(19) United States
(12) Patent Application Publication
(10) Pub. No.: US 2020/0394289 A1
(43) Pub. Date: Dec. 17, 2020

(54) BIOMETRIC VERIFICATION FRAMEWORK THAT UTILIZES A CONVOLUTIONAL NEURAL NETWORK FOR FEATURE MATCHING

(71) Applicant: Microsoft Technology Licensing, LLC, Redmond, WA (US)

(72) Inventors: Ivan RAZUMENIC, Belgrade (RS); Radim SPETLÍK, Liberec (CZ)

(21) Appl. No.: 16/583,599

(22) Filed: Sep. 26, 2019

Related U.S. Application Data
(60) Provisional application No. 62/861,801, filed on Jun. 14, 2019.

(51) Int. Cl. G06F 21/32; G06N 3/04; G06F 17/15; G06K 9/00; G06T 19/00; G02B 27/01

(52) U.S. Cl. CPC G06F 21/32; G06N 3/0454; G02B 27/017; G06K 9/00288; G06T 19/006; G06F 17/15

(57) ABSTRACT

A method for biometric verification includes obtaining a verification image and extracting a set of verification image features from the verification image. The method also includes processing the set of verification image features and a set of enrollment image features using a convolutional neural network to determine a metric. A determination may then be made about whether the verification image matches an enrollment image based on the metric.

### CROSS-REFERENCE TO RELATED APPLICATIONS

This application is related to and claims the benefit of U.S. Provisional Patent Application Ser. No. 62/861,801, filed Jun. 14, 2019, titled “BIOMETRIC VERIFICATION FRAMEWORK THAT UTILIZES A CONVOLUTIONAL NEURAL NETWORK FOR FEATURE MATCHING.” The aforementioned application is expressly incorporated herein by reference in its entirety.

### BACKGROUND

The techniques disclosed herein are generally related to biometric verification. In general terms, biometric verification is any means by which a person can be uniquely identified by evaluating one or more distinguishing biological traits. The present disclosure is specifically directed to biometric verification techniques in which some of a person's uniquely identifying characteristics are represented in a digital image.

Iris verification is one example of a biometric verification technique that involves the comparison of digital images. The iris is the colored ring of the eye and its patterns are unique to each individual. Iris verification involves analyzing digital images of the unique, random patterns in the iris portion of the eye.

Generally speaking, a person's interaction with an iris verification system begins with an enrollment stage. When a person participates in the enrollment stage, an iris verification system learns to recognize that person. Subsequent verification attempts rely on information that is obtained during the enrollment stage.

Both the enrollment stage and any subsequent verification attempts involve capturing one or more images of a person's eyes (either a single eye or both eyes). The images may be image frames that are captured as part of a video sequence. The captured images are processed to detect the iris and identify unique features of the iris. Images that are captured during the enrollment stage may be referred to herein as enrollment images. Images that are captured during subsequent verification attempts may be referred to herein as verification images.

An iris verification pipeline may be split into two phases. The first phase compares pairs of images (one enrollment image and one verification image) and calculates a metric that indicates the likelihood of a match between the enrollment image and the verification image. In the second phase of the iris verification pipeline, metrics from multiple instances of the first phase may be aggregated with simple heuristics. For example, the maximum metric between a plurality of enrollment images and one verification image may be compared to a fixed threshold to find a match, and verification images may be processed until a match is found or a timeout is reached.

Generally speaking, a comparison of an enrollment image and a verification image has three phases: iris detection, feature extraction, and matching. Detection involves locating an iris in an image and normalizing the image for purposes of iris verification. In this context, normalization is the process of converting the portion of the image that corresponds to the iris (which is donut-shaped) to a rectangular image. With traditional approaches to feature extraction, the normalized image is convolved with linear filters (e.g., Gabor filters) and converted into a “bitcode,” i.e., a matrix of binary numbers. For matching, two bitcodes are compared (one bitcode corresponding to an enrollment image, and another bitcode corresponding to a verification image) by calculating a metric that indicates the level of similarity between the bitcodes (e.g., the Hamming distance). A match is declared if the metric compares favorably with a pre-defined threshold.

Facial recognition is another example of a biometric verification technique that involves the use of digital images. Facial recognition is similar in some respects to iris verification. For example, a person's interaction with a facial recognition system begins with an enrollment stage, and subsequent verification attempts rely on information that is obtained during the enrollment stage. Moreover, both the enrollment stage and any subsequent verification attempts involve capturing one or more images. Whereas iris verification involves capturing one or more images of a person's eyes, facial recognition involves capturing one or more images of a person's entire face. Like iris verification, facial recognition may include at least three phases: detection, feature extraction, and matching.

Other biometric verification techniques may compare enrollment and verification images of other distinguishing biological traits, such as retina patterns, fingerprints, hand geometry, and earlobe geometry. Even voice waves could potentially be represented in a digital image, by transforming the voice waves into a spectrogram. The spectrogram could have time on one axis and frequency (of the available signal in the waveform) on the other.

Current biometric verification techniques suffer from various drawbacks. As one example, feature extraction and matching are highly data dependent in a common iris verification pipeline and therefore require extensive parameter tuning. Since the task is not convex, an exhaustive search for parameters is performed. Benefits may be realized by improved techniques for biometric verification that do not depend on this type of extensive parameter tuning.

### SUMMARY

In accordance with one aspect of the present disclosure, a computer-readable medium includes instructions that are executable by one or more processors to cause a computing device to obtain a verification image and extract a set of verification image features from the verification image. The set of verification image features may be processed along with a set of enrollment image features using a convolutional neural network to determine a metric. A determination may be made about whether the verification image matches an enrollment image based on the metric.

In some embodiments, the enrollment image and the verification image may both include a human iris. In some embodiments, the enrollment image and the verification image may both include a human face.

The set of verification image features may be extracted from the verification image using a set of verification complex-response layers. The computer-readable medium may further include additional instructions that are executable by the one or more processors to obtain the enrollment image and extract the set of enrollment image features from the enrollment image using a set of enrollment complex-response layers.

The computer-readable medium may further include additional instructions that are executable by the one or more processors to process a plurality of sets of enrollment image features with the set of verification image features using the convolutional neural network to determine the metric.

The convolutional neural network may be included in a recurrent neural network, and may further include additional instructions that are executable by the one or more processors to obtain a plurality of verification images, extract a plurality of sets of verification image features from the plurality of verification images, and process each set of verification image features with the set of enrollment image features to determine a plurality of metrics. The metric that is determined in connection with processing a particular set of verification image features may depend on information obtained in connection with processing one or more previous sets of verification image features.

The computer-readable medium may further include additional instructions that are executable by the one or more processors to determine an additional metric that indicates a likelihood that the plurality of verification images correspond to a live human being.

The convolutional neural network may be included in a recurrent neural network, and may further include additional instructions that are executable by the one or more processors to obtain a plurality of sets of enrollment image features corresponding to a plurality of enrollment images, obtain a plurality of verification images, extract a plurality of sets of verification image features from the plurality of verification images, and process each set of verification image features with the plurality of sets of enrollment image features to determine a plurality of metrics. The metric that is determined in connection with processing a particular set of verification image features may depend on information obtained in connection with processing one or more previous sets of verification image features.

The computer-readable medium may further include additional instructions that are executable by the one or more processors to determine an additional metric that indicates a likelihood that the plurality of verification images correspond to a live human being.

In some embodiments, the enrollment image may include a left-eye enrollment image, and the verification image may include a left-eye verification image. The convolutional neural network may include a left-eye convolutional neural network, and may further include additional instructions that are executable by the one or more processors to obtain right-eye enrollment image features that are extracted from a right-eye enrollment image, obtain right-eye verification image features that are extracted from a right-eye verification image, and process the right-eye enrollment image features and the right-eye verification image features using a right-eye convolutional neural network. The metric may depend on output from the left-eye convolutional neural network and the right-eye convolutional neural network.

In accordance with another aspect of the present disclosure, a computing device is disclosed that includes a camera, one or more processors, memory in electronic communication with the one or more processors, and a set of enrollment image features stored in the memory. The set of enrollment image features correspond to an enrollment image. The computing device also includes instructions stored in the memory. The instructions are executable by the one or more processors to cause the camera to capture a verification image, extract a set of verification image features from the verification image, process the set of verification image features and the set of enrollment image features using a convolutional neural network to determine a metric, and determine whether the verification image matches the enrollment image based on the metric.

The computing device may further include additional instructions that are executable by the one or more processors to receive a user request to perform an action and perform the action in response to determining that the metric exceeds a pre-defined threshold value.

In some embodiments, the computing device may include a head-mounted mixed reality device. The action may include loading a user model corresponding to a user of the computing device.

The computing device may further include a plurality of sets of enrollment image features stored in the memory and additional instructions that are executable by the one or more processors to process the plurality of sets of enrollment image features with the set of verification image features using the convolutional neural network to determine the metric.

The computing device may further include additional instructions that are executable by the one or more processors to cause the camera to capture a plurality of verification images, extract a plurality of sets of verification image features from the plurality of verification images, and process each set of verification image features with the set of enrollment image features to determine a plurality of metrics. The metric that is determined in connection with processing a particular set of verification image features may depend on information obtained in connection with processing one or more previous sets of verification image features.

FILED ELECTRONICALLY Docket No. 406894-US-NP

The computing device may further include additional instructions that are executable by the one or more processors to determine an additional metric that indicates a likelihood that the plurality of verification images correspond to a live human being.

The convolutional neural network may be included in a recurrent neural network and may further include additional instructions that are executable by the one or more processors to obtain a plurality of sets of enrollment image features corresponding to a plurality of enrollment images, cause the camera to capture a plurality of verification images, extract a plurality of sets of verification image features from the plurality of verification images, and process each set of verification image features with the plurality of sets of enrollment image features to determine a plurality of metrics. The metric that is determined in connection with processing a particular set of verification image features may depend on information obtained in connection with processing one or more previous sets of verification image features.

The computing device may further include additional instructions that are executable by the one or more processors to determine an additional metric that indicates a likelihood that the plurality of verification images correspond to a live human being.

In accordance with another aspect of the present disclosure, a system can include one or more processors, memory in electronic communication with the one or more processors, and instructions stored in the memory. The instructions are executable by the one or more processors to receive a request from a client device to perform biometric verification and to receive a verification image from the client device. The instructions are also executable by the one or more processors to process a set of verification image features and a set of enrollment image features using a convolutional neural network to determine a metric. A verification result may be determined based on the metric, and the verification result may be sent to the client device.

In some embodiments, the system includes additional instructions that are stored in the memory and executable by the one or more processors to extract the set of verification image features from the verification image, obtain an enrollment image, and extract the set of enrollment image features from the enrollment image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates one example of an iris verification system in accordance with the present disclosure.

FIG. 2 illustrates another example of an iris verification system in accordance with the present disclosure, in which feature extraction is performed using complex-response (C-R) layers.

FIG. 2A illustrates an example of one possible implementation of the iris verification system shown in FIG. 2.

FIG. 3 illustrates an example of a method for biometric verification in accordance with the present disclosure.

FIG. 3A illustrates an example of a system that is configured to implement the method shown in FIG. 3.

FIG. 4 illustrates an example of an iris verification system that is configured to incorporate a plurality of enrollment observations.

FIG. 5 illustrates an example of a method for biometric verification in a biometric verification system that accommodates a plurality of enrollment observations.

FIG. 6 illustrates an example of an iris verification system that is configured to utilize temporal information in connection with iris verification.

FIG. 7 illustrates an example of a method for biometric verification in a biometric verification system that utilizes temporal information in connection with biometric verification.

FIG. 8 illustrates another example of an iris verification system in accordance with the present disclosure.

FIG. 9 illustrates an example of a method for biometric verification in a biometric verification system that utilizes temporal information in connection with biometric verification and also accommodates a plurality of enrollment observations.

FIG. 10 illustrates another example of an iris verification system in accordance with the present disclosure.

FIG. 11 illustrates certain components that may be included within a computing device that is configured to implement the techniques disclosed herein.

FIG. 12 illustrates an example of a method for biometric verification that may be performed by the computing device shown in FIG. 11.

### DETAILED DESCRIPTION

One aspect of the present disclosure is related to improved biometric verification techniques that involve the comparison of digital images. The techniques disclosed herein involve the use of convolutional neural networks (CNNs). As discussed above, biometric verification techniques that involve the comparison of digital images may include a matching phase. In accordance with one aspect of the present disclosure, the operation of matching in a biometric verification technique may be carried out with a CNN, which may be referred to herein as a matching CNN. Advantageously, the matching CNN learns to match extracted features instead of using fixed metrics (such as the Hamming distance), as is the case with currently known approaches. This makes it unnecessary to perform an exhaustive search for parameters. As a result, biometric verification techniques that utilize a matching CNN as taught herein can be more accurate and/or less computationally intensive than known biometric verification approaches. These and other advantages associated with the biometric verification techniques will be discussed below.

When an enrollment image and a verification image are compared, the results of feature extraction analysis for both the enrollment image and the verification image may be provided to the matching CNN as inputs. The matching CNN may be trained so that it outputs a metric that indicates the probability of a match between the enrollment image and the verification image. In this context, a match between the enrollment image and the verification image means that the enrollment image and the verification image both correspond to the same person (i.e., the same person provided both the enrollment image and the verification image).

In accordance with another aspect of the present disclosure, feature extraction may be performed using a set of complex-response (C-R) layers. As will be described in greater detail below, the C-R layers may also be implemented using a CNN, with certain constraints. The network that is formed by the C-R layers and the matching CNN may be trained “end-to-end.” In other words, the C-R layers and the matching CNN may be trained using the backward propagation of errors (backpropagation). The C-R layers and the matching CNN may be trained so that the matching CNN outputs a metric that indicates the probability of a match between the enrollment image and the verification image. In some implementations, the C-R layers and the matching CNN may be trained using a binary cross-entropy loss function.

Advantageously, the biometric verification framework disclosed herein may be easily expanded to incorporate a plurality of enrollment observations. As discussed above, the first phase of a biometric verification pipeline may involve a comparison between a single enrollment image and a single verification image. However, the use of a CNN for matching, as disclosed herein, enables a plurality of enrollment images to be compared to the verification image. The matching CNN may be trained to process a plurality of sets of features extracted from a plurality of enrollment images along with the set of features from the verification image.

A biometric verification framework as disclosed herein also enables temporal information to be used in connection with biometric verification. In other words, instead of performing a comparison involving just a single verification image, the techniques disclosed herein enable a comparison to be performed involving a plurality of verification images. As an example involving iris verification, the plurality of verification images may be image frames from a video of a person's eye that is taken at the time that verification is performed. To facilitate this type of approach, a recurrent neural network (RNN)-based framework may be utilized. The RNN-based framework may include a matching CNN, and it may also be configured to aggregate matching confidence over time as additional verification images are processed.

The techniques disclosed herein provide a number of advantages relative to known approaches for biometric verification. For example, good accuracy can be achieved even in cases of highly occluded observations (e.g., from sun glares or glass frames) or very poor sensor quality. The latter case enables less expensive image sensors to be used for image capture, which may also potentially reduce the size of the image sensor. Alternatively, for a given image sensor, the techniques disclosed herein can verify users more quickly than traditional approaches, and/or with higher accuracy.

The increase in accuracy provided by the disclosed techniques may be especially important in the case of biometric recognition (e.g., iris recognition, facial recognition), which involves recognizing a user from a pool of all possible users known to a particular system. For example, iris recognition involves performing multiple attempts at iris verification with a pool of potential users (e.g., registered users). With an increase in the number of users who are registered in the database, the accuracy of the recognition system drops for the same level of iris verification accuracy. Hence, the improved accuracy that can be achieved by the iris verification techniques disclosed herein may yield benefits in connection with performing iris recognition. Given a system with many registered users, it can be important to have very accurate techniques for iris verification. Similar advantages can be achieved from the use of the disclosed techniques in connection with other types of biometric verification systems, such as those mentioned previously.

The techniques disclosed herein may also be used to perform liveness detection. In this context, the term “liveness detection” may refer to any technique for attempting to prevent imposters from gaining access to something (e.g., a device, a building or a space within a building). An imposter may, for example, attempt to trick an iris verification system by presenting an image of another person's eye to the camera, or playing a video of another person in front of the camera. An RNN-based framework that enables a comparison to be performed involving a plurality of verification images may be trained to provide an additional output that indicates the likelihood that the plurality of verification images correspond to a live human being and is not a spoof attempt.

For purposes of example, at least some of the figures illustrate the techniques disclosed in the context of iris verification. However, this should not be interpreted as limiting the scope of the present disclosure. As discussed above, the techniques disclosed herein may be used in connection with any type of biometric verification system in which some of a person's uniquely identifying characteristics are represented in a digital image, including (but not limited to) the specific examples provided above.

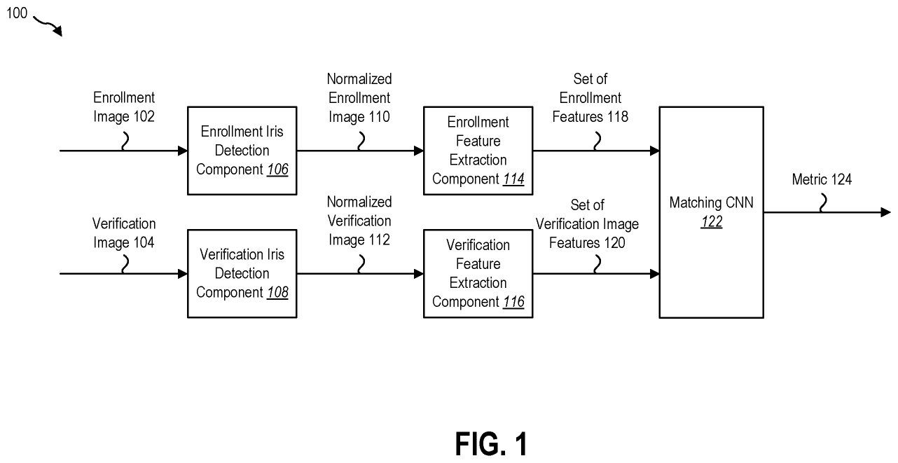

FIG. 1 illustrates one example of an iris verification system 100 in accordance with the present disclosure. The system 100 shown in FIG. 1 is configured to determine the probability of a match between an enrollment image 102 and a verification image 104. In other words, the system 100 is configured to determine the probability that an enrollment image 102 and a verification image 104 both correspond to the same eye. The system 100 includes an iris detection section, a feature extraction section, and a matching section.

The iris detection section includes an iris detection component 106 for the enrollment image 102 and an iris detection component 108 for the verification image 104. To distinguish between these iris detection components 106, 108, the iris detection component 106 for the enrollment image 102 will be referred to herein as the enrollment iris detection component 106, and the iris detection component 108 for the verification image 104 will be referred to herein as the verification iris detection component 108. The enrollment iris detection component 106 and the verification iris detection component 108 may represent two different instances of the same iris detection component, and they may utilize the same or substantially similar algorithms for iris detection.

The enrollment iris detection component 106 performs iris detection with respect to the enrollment image 102 and outputs a normalized image 110 corresponding to the enrollment image 102. This normalized image 110 will be referred to as a normalized enrollment image 110. The verification iris detection component 108 performs iris detection with respect to the verification image 104 and outputs a normalized image 112 corresponding to the verification image 104. This normalized image 112 will be referred to as the normalized verification image 112.

The feature extraction section includes a feature extraction component 114 for the enrollment image 102 and a feature extraction component 116 for the verification image 104. To distinguish between these feature extraction components 114, 116, the feature extraction component 114 for the enrollment image 102 will be referred to herein as the enrollment feature extraction component 114, and the feature extraction component 116 for the verification image 104 will be referred to herein as the verification feature extraction component 116. The enrollment feature extraction component 114 and the verification feature extraction component 116 may represent two different instances of the same feature extraction component, and they may utilize the same or substantially similar algorithms for feature extraction.

In some embodiments, the enrollment feature extraction component 114 and the verification feature extraction component 116 may utilize conventional feature extraction techniques. Alternatively, the enrollment feature extraction component 114 and the verification feature extraction component 116 may utilize a novel complex-response (C-R) layer that will be discussed in greater detail below.

The enrollment feature extraction component 114 processes the normalized enrollment image 110 to extract a set of features from the normalized enrollment image 110. This set of features will be referred to as a set of enrollment image features 118. The verification feature extraction component 116 processes the normalized verification image 112 to extract a set of features from the normalized verification image 112. This set of features will be referred to as a set of verification image features 120.

The matching section includes a CNN 122 that will be referred to herein as a matching CNN 122. The matching CNN 122 processes the set of enrollment image features 118 and the set of verification image features 120 to determine a metric 124 that indicates the probability of a match between the enrollment image 102 and the verification image 104.

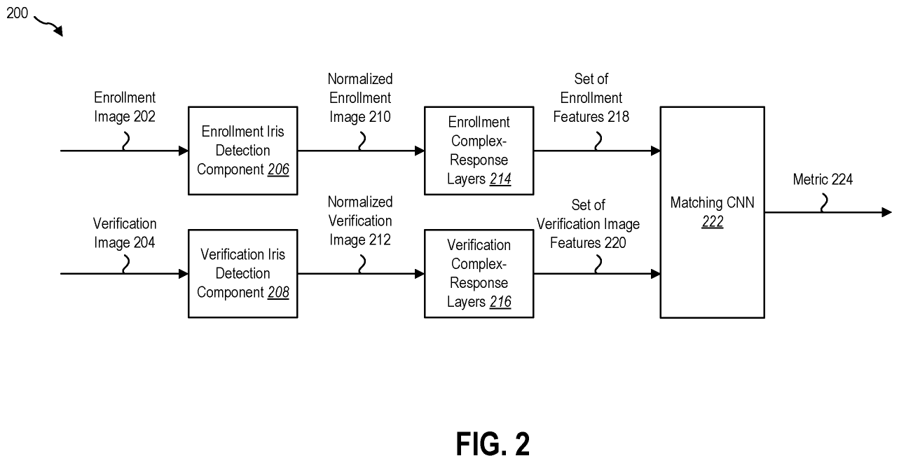

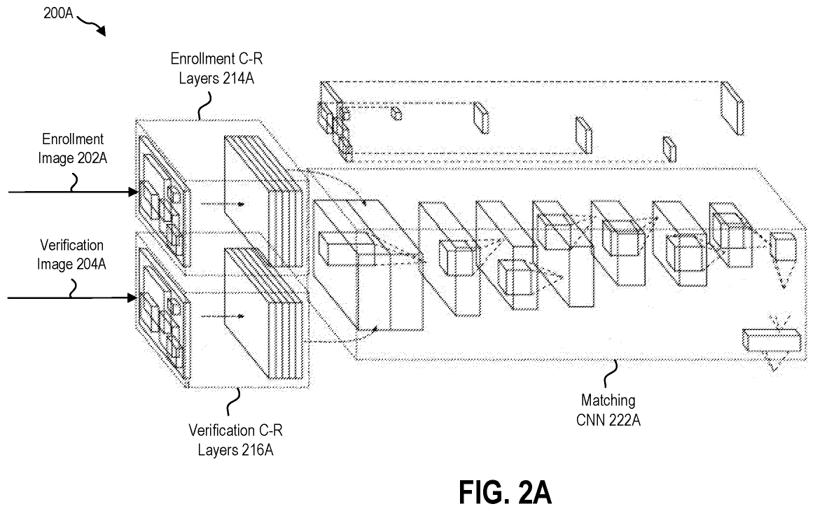

FIG. 2 illustrates another example of an iris verification system 200 in accordance with the present disclosure. Like the system 100 discussed previously, the system 200 shown in FIG. 2 is configured to determine the probability of a match between an enrollment image 202 and a verification image 204. The system 200 also includes an iris detection section, a feature extraction section, and a matching section. In the system 200 shown in FIG. 2, however, feature extraction is performed using complex-response (C-R) layers.

The iris detection section includes an enrollment iris detection component 206 and a verification iris detection component 208 that may be similar to the corresponding components in the system 100 that was discussed previously in connection with FIG. 1. The enrollment iris detection component 206 performs iris detection with respect to the enrollment image 202 and outputs a normalized enrollment image 210 corresponding to the enrollment image 202. The verification iris detection component 208 performs iris detection with respect to the verification image 204 and outputs a normalized verification image 212 corresponding to the verification image 204.

The feature extraction section includes a set of C-R layers 214 for the enrollment image 202 and a set of C-R layers 216 for the verification image 204. To distinguish between these C-R layers 214, 216, the C-R layers 214 for the enrollment image 202 will be referred to herein as the enrollment C-R layers 214, and the C-R layers 216 for the verification image 204 will be referred to herein as the verification C-R layers 216. The enrollment C-R layers 214 and the verification C-R layers 216 may represent two different instances of the same C-R layer, and they may utilize the same or substantially similar algorithms for feature extraction.

The enrollment C-R layers 214 extract a set of features from a normalized enrollment image 210 that is output by the enrollment iris detection component 206. This set of features will be referred to as a set of enrollment image features 218. The verification C-R layers 216 extract a set of features from a normalized verification image 212 that is output by the verification iris detection component 208. This set of features will be referred to as a set of verification image features 220.

The matching section includes a matching CNN 222. The set of enrollment image features 218 and the set of verification image features 220 may be concatenated and provided as input to the matching CNN 222. The matching CNN 222 processes the set of enrollment image features 218 and the set of verification image features 220 to determine a metric 224 that indicates the probability of a match between the enrollment image 202 and the verification image 204.

An example will now be described of one possible implementation of a set of C-R layers and a matching CNN. Let τ={(x₁^{j}, . . . , x_{N}_{ⱼ}^{j})ϵχ^{N}^{ⱼ}|j=1, . . . , l} be a training set that contains l tuples of normalized iris images xϵχ. Each tuple contains Nⱼ images of the same iris. Symbol χ denotes the set of all input iris images.

An example of an implementation of a set of C-R layers will be described first. Let c(xₖ; ϕ) be the output of a standard convolutional layer with a single input channel and two output channels for the k-th normalized iris image, where ϕ is a concatenation of the parameters of the filter. The output of the C-R layer c̊(xₖ; ϕ) on the i-th row and j-th column may be defined as:

$${{c}^{•}}_{( i , j )} ( {x}_{k} ; φ ) = \frac{{c}_{( i , j )} ( {x}_{k} ; φ )}{{‖ {c}_{( i , j )} ( {x}_{k} ; φ ) ‖}_{2}} \qquad ( 1 )$$

In this example, the output of the C-R layer is the output of a standard convolutional layer that is normalized along the output channel dimension. In other words, the convolutional layer has one input channel and two output channels. The output of the C-R layer may be interpreted as the normalized response of the filter in the complex plane.

An example of an implementation of the matching CNN will now be described. In this example, the matching CNN produces a single scalar representing the probability that the two irises match. Let the expression g(x̅_{q,r}; Ψ) represent the output of the matching CNN for the pair of q-th and r-th normalized iris images. In addition, let the symbol Ψ represent a concatenation of all convolutional filter parameters. The input of the matching CNN may be represented as x̅_{q,r}=(c̊(x_{q};Φ), c̊(xᵣ;Φ)), where c̊(x_{q};Φ) is the output of all C-R layers for the normalized iris x_{q} and Φ is a concatenation of the parameters of filters of all C-R layers.

In other words, the input to the matching CNN may be created as follows. A normalized iris may be fed to the C-R layers. The output of the C-R layers may be concatenated. The same procedure may be repeated for the second normalized iris. Finally, the two sets of responses may be concatenated creating the input to the matching CNN.

FIG. 2A illustrates an example of one possible implementation of the iris verification system 200 shown in FIG. 2. The iris verification system 200A shown in FIG. 2A includes a set of enrollment C-R layers 214A, a set of verification C-R layers 216A, and a matching CNN 222A. The enrollment C-R layers 214A, verification C-R layers 216A, and matching CNN 222A include a plurality of filter banks that are arranged so that the output of the matching CNN 222A is a metric that indicates the probability of a match between an enrollment image 202A and a verification image 204A.

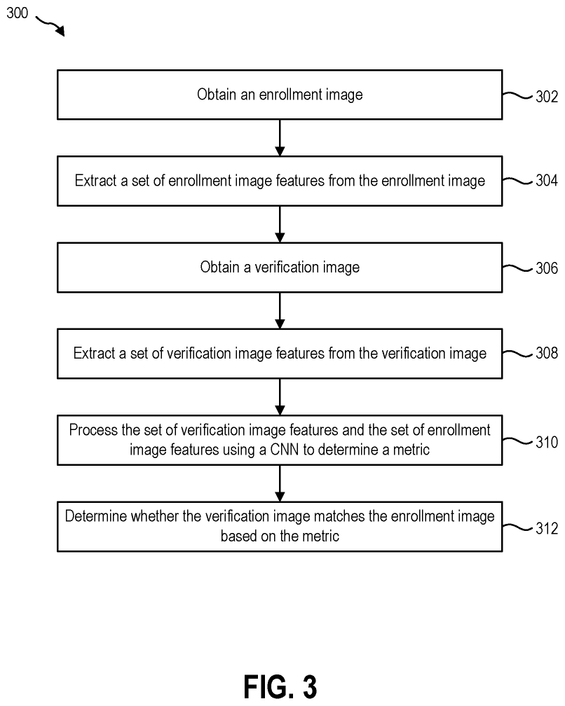

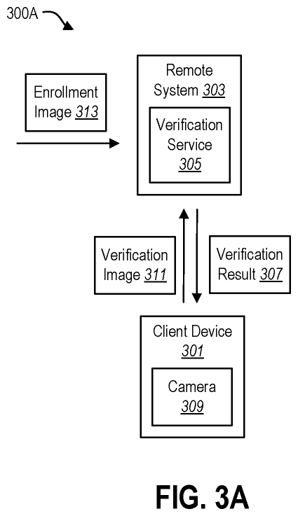

FIG. 3 illustrates an example of a method 300 for biometric verification in accordance with the present disclosure. The method 300 may be performed by one or more computing devices. The method 300 will be described in relation to the system 200 shown in FIG. 2.

The method 300 includes obtaining 302 an enrollment image 202 and extracting 304 a set of enrollment image features 218 from the enrollment image 202. The method 300 also includes obtaining 306 a verification image 204 and extracting 308 a set of verification image features 220 from the verification image 204.

In some embodiments, a computing device that is being used to perform the method 300 may include a camera. In such embodiments, the action of obtaining 302 the enrollment image 202 may include causing the camera to capture the enrollment image 202. Similarly, the action of obtaining 302 the verification image 204 may include causing the camera to capture the verification image 204. In other embodiments, obtaining 302 the enrollment image 202 may include receiving the enrollment image 202 from another device that has captured the enrollment image 202. Similarly, obtaining 306 the verification image 204 may include receiving the verification image 204 from another device that has captured the verification image 204.

In some embodiments, feature extraction may be performed using complex-response (C-R) layers 214, as described above. Alternatively, feature extraction may be performed using conventional feature extraction techniques, which may involve pattern recognition.

In some embodiments, the action of extracting 304 a set of enrollment image features 218 from an enrollment image 202 may include extracting 304 a set of enrollment image features 218 from a normalized enrollment image 210. In other words, the enrollment image 202 may be processed in order to detect the relevant characteristic (e.g., an iris in the case of iris verification, a face in the case of facial recognition), thereby producing a normalized enrollment image 210. In other embodiments, the set of enrollment image features 218 may be extracted directly from an enrollment image 202 without an additional detection action that produces a normalized enrollment image 210.

Similarly, the action of extracting 308 a set of verification image features 220 from a verification image 204 may include extracting 308 a set of verification image features 220 from a normalized verification image 212. Alternatively, the set of verification image features 220 may be extracted directly from a verification image 204 without an additional detection action that produces a normalized verification image 212.

The method 300 also includes processing 310 the set of enrollment image features 218 and the set of verification image features 220 using a matching CNN 222 in order to determine a metric 224. In some embodiments, the processing involving the matching CNN 222 may occur in accordance with the example implementation described above. As indicated above, in some embodiments, the matching CNN 222 may include a plurality of filter banks that are arranged to output the metric 224.

The method 300 also includes determining 312 whether the verification image 204 matches the enrollment image 202 based on the metric 224. In some embodiments, if the metric 224 exceeds a pre-defined threshold value, then a determination is made that the verification image 204 matches the enrollment image 202. If, however, the metric 224 does not exceed the threshold value, then a determination is made that the verification image 204 does not match the enrollment image 202.

In some embodiments, a computing device may perform some, but not all, of the actions of the method 300. For example, instead of performing the actions of obtaining 302 an enrollment image 202 and extracting 304 a set of enrollment image features 218 from the enrollment image 202, a computing device may instead obtain a set of enrollment image features 218 from another device. The computing device may then obtain 306 a verification image 204 and perform the rest of the method 300 in the manner described above.

In some embodiments, a client device can interact with a remote system to perform the method 300. For example, referring to the system 300A shown in FIG. 3A, a client device 301 that includes a camera 309 can capture a verification image 311 and send the verification image 311 to a remote system 303 for processing. The remote system 303 can include a verification service 305 that performs biometric verification using a matching CNN in accordance with the techniques disclosed herein. Based on the results of the biometric verification, the remote system 303 can determine a verification result 307 and send the verification result 307 back to the client device 301.

Referring to both the method 300 shown in FIG. 3 and the system 300A shown in FIG. 3A, in some embodiments, the client device 301 can perform the action of obtaining 306 a verification image 311 and the verification service 305 implemented by the remote system 303 can perform the remaining actions of the method 300. The enrollment image 313 that the matching CNN processes along with the verification image 311 can be stored on the remote system 303, obtained from the client device 301, or obtained from another entity.

In other embodiments, the client device 301 can perform the actions of obtaining 302 the enrollment image 313, extracting a set of enrollment image features from the enrollment image 313, obtaining the verification image 311, and extracting a set of verification image features from the verification image 311. The client device 301 can then send the set of enrollment image features and the set of verification image features to the remote system 303. The verification service 305 can then perform the remaining actions of the method 300 and return a verification result 307 to the client device 301.

In some embodiments, the remote system 303 can be a cloud computing service, and the verification service 305 implemented by the remote system 303 can be a cloud computing service. The client device 301 can be, for example, a laptop computer, a smartphone, a tablet computer, a desktop computer, a smartwatch, a virtual reality headset, a fitness tracker, or the like. Communication between the client device 301 and the remote system 303 can occur via one or more computer networks, which can include the Internet.

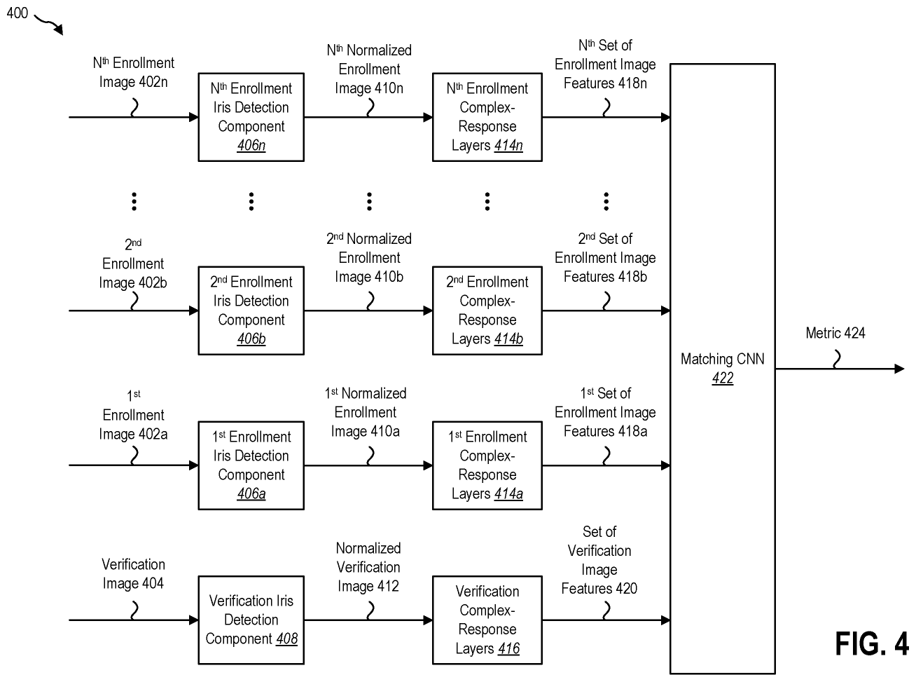

As discussed above, the biometric verification framework disclosed herein may be expanded to incorporate a plurality of enrollment observations. FIG. 4 illustrates an example of an iris verification system 400 that is configured to incorporate a plurality of enrollment observations. In particular, the system 400 is configured to determine the probability of a match between a verification image 404 and a plurality of enrollment images 406a-n. In the depicted example, the plurality of enrollment images 406a-n include a first enrollment image 406a, a second enrollment image 406b, and an Nth enrollment image 406c. Like the systems 100, 200 discussed previously, the system 400 shown in FIG. 4 includes an iris detection section, a feature extraction section, and a matching section.

The iris detection section includes an enrollment iris detection component for each of the plurality of enrollment images 402a-n. In particular, FIG. 4 shows the iris detection section with a first enrollment iris detection component 406a, a second enrollment iris detection component 406b, and an Nth enrollment iris detection component 406n. The first enrollment iris detection component 406a performs iris detection with respect to the first enrollment image 402a and outputs a first normalized enrollment image 410a. The second enrollment iris detection component 406b performs iris detection with respect to the second enrollment image 402b and outputs a second normalized enrollment image 410b. The Nth enrollment iris detection component 406n performs iris detection with respect to the Nth enrollment image 402n and outputs an Nth normalized enrollment image 410n. The iris detection section also includes a verification iris detection component 408 that performs iris detection with respect to the verification image 404 and outputs a normalized verification image 412.

The feature extraction section includes a set of enrollment C-R layers for each of the plurality of enrollment images 406a-n. In particular, FIG. 4 shows the feature extraction section with a first set of enrollment C-R layers 414a, a second set of enrollment C-R layers 406b, and an Nth set of enrollment C-R layers 406n. The first set of enrollment C-R layers 414a extracts a first set of enrollment image features 418a from the first normalized enrollment image 410a. The second set of enrollment C-R layers 414b extracts a second set of enrollment image features 418b from the second normalized enrollment image 410b. The Nth set of enrollment C-R layers 414n extracts an Nth set of enrollment image features 418n from the Nth normalized enrollment image 410n. The feature extraction section also includes verification C-R layers 416 that process the normalized verification image 412 to extract a set of verification image features 420.

The matching section includes a matching CNN 422 that may be similar to the matching CNNs 122, 222 discussed previously, except that the matching CNN 422 in the system 400 shown in FIG. 4 may be trained to accommodate a plurality of enrollment observations. The matching CNN 422 processes the first set of enrollment image features 418a, the second set of enrollment image features 418b, the Nth set of enrollment image features 418n, and the set of verification image features 420 to determine a metric 424 that indicates the probability of a match between the verification image 404 and the plurality of enrollment images 406a-n. In other words, the metric 424 may indicate the probability that the verification image 404 corresponds to the same human eye as the plurality of enrollment images 406a-n.

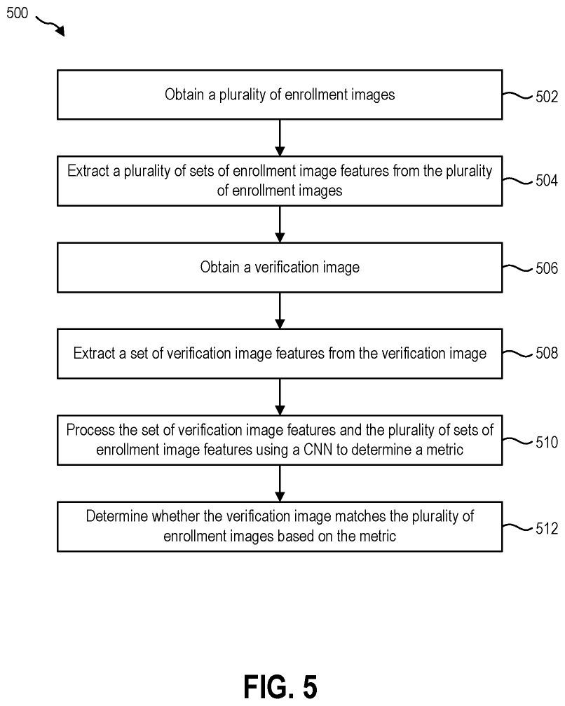

FIG. 5 illustrates an example of a method 500 for biometric verification in a biometric verification system that accommodates a plurality of enrollment observations. The method 500 may be performed by one or more computing devices. The method 500 will be described in relation to the system 400 shown in FIG. 4.

The method 500 includes obtaining 502 a plurality of enrollment images 402a-n and extracting 504 a plurality of sets of enrollment image features 418a-n from the plurality of enrollment images 402a-n. These actions 502, 504 may be similar to the corresponding actions 302, 304 that were described above in connection with the method 300 shown in FIG. 3, except that the actions 502, 504 shown in FIG. 5 involve a plurality of enrollment images 402a-n and a plurality of sets of enrollment image features 418a-n instead of just a single enrollment image 202 and a single set of enrollment image features 202a-n.

The method 500 also includes obtaining 506 a verification image 404 and extracting 508 a set of verification image features 420 from the verification image 404. These actions 506, 508 may be similar to the corresponding actions 306, 308 that were described above in connection with the method 300 shown in FIG. 3.

The method 500 also includes processing 510 the set of verification image features 420 and the plurality of sets of enrollment image features 418a-n using a matching CNN 422 in order to determine a metric 424. In addition, the method 500 includes determining 512 whether the verification image 404 matches the plurality of enrollment images 402a-n based on the metric 424. These actions 510, 512 may be similar to the corresponding actions 310, 312 that were described above in connection with the method 300 shown in FIG. 3, except that the actions 510, 512 shown in FIG. 5 involve a plurality of enrollment images 402a-n and a plurality of sets of enrollment image features 418a-n instead of just a single enrollment image 202 and a single set of enrollment image features 202a-n.

As with the method 300 shown in FIG. 3, a computing device may perform some, but not all, of the actions of the method 500. For example, instead of performing the actions of obtaining 502 a plurality of enrollment images 402a-n and extracting 504 a plurality of sets of enrollment image features 418a-n from the plurality of enrollment images 402a-n, a computing device may instead obtain a plurality of sets of enrollment image features 418a-n from another device. The computing device may then obtain 506 a verification image 404 and perform the rest of the method 500 in the manner described above.

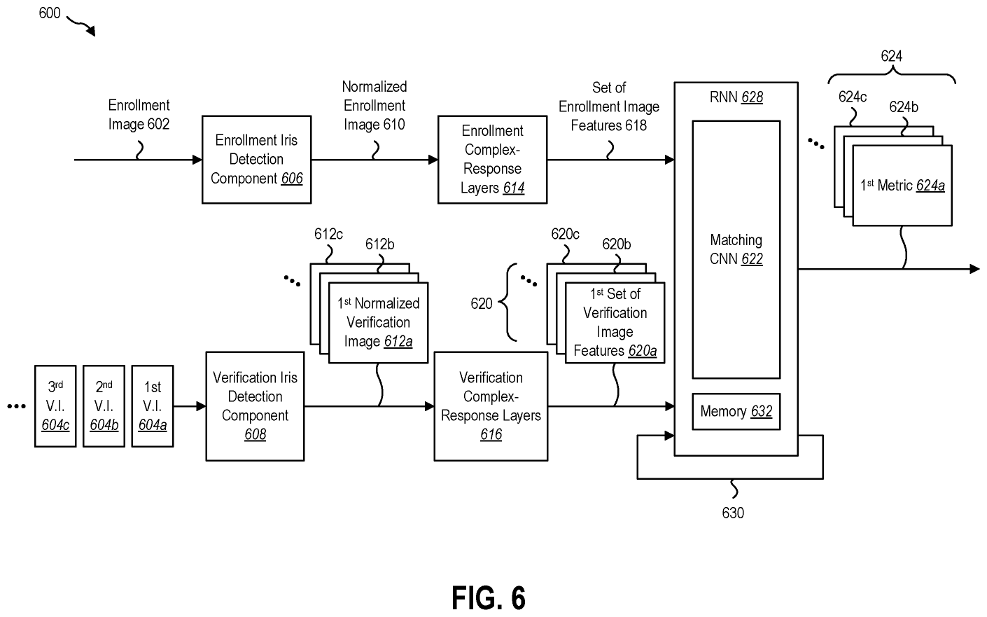

As indicated above, a biometric verification framework as disclosed herein also enables temporal information to be used in connection with biometric verification. FIG. 6 illustrates an example of an iris verification system 600 that is configured to utilize temporal information in connection with iris verification. In particular, whereas the systems 100, 200, 400 described previously perform a comparison involving just a single verification image 104, 204, 404, the system 600 shown in FIG. 6 performs a comparison involving a plurality of verification images 604a-c. The plurality of verification images 604a-c may be, for example, image frames from a video of a person's eye that is taken at the time that verification is performed. Like the systems 100, 200, 400 discussed previously, the system 600 shown in FIG. 6 includes an iris detection section, a feature extraction section, and a matching section.

The iris detection section includes an enrollment iris detection component 606 that performs iris detection with respect to the enrollment image 602 and outputs a normalized enrollment image 610 corresponding to the enrollment image 602. The iris detection section also includes a verification iris detection component 608. The verification iris detection component 608 performs iris detection with respect to each of the plurality of verification images 604a-c. For each verification image, the verification iris detection component 608 outputs a normalized verification image corresponding to the verification image. Thus, the verification iris detection component 608 (i) performs iris detection with respect to the first verification image 604a to produce a first normalized verification image 612a, (ii) performs iris detection with respect to the second verification image 604b to produce a second normalized verification image 612b, (iii) performs iris detection with respect to the third verification image 604c to produce a third normalized verification image 612c, and so forth.

The feature extraction section includes a set of enrollment C-R layers 614 and a set of verification C-R layers 616. The enrollment C-R layers 614 extract a set of enrollment image features 618 from the normalized enrollment image 610. The verification C-R layers 616 extract a set of enrollment image features from each of the normalized verification images 612a-c. In particular, the verification C-R layer 616 (i) extracts a first set of verification image features 620a from the first normalized verification image 612a, (ii) extracts a second set of verification image features 620b from the second normalized verification image 612b, (iii) extracts a third set of verification image features 620c from the third normalized verification image 612c, and so forth.

The matching section includes a recurrent neural network (RNN) 628. The RNN 628 includes a matching CNN 622 that processes the set of enrollment image features 618 along with a particular set of verification image features from a particular verification image to determine a metric that indicates the probability of a match between the enrollment image 602 and the verification image under consideration. Thus, the matching CNN 622 (i) processes the set of enrollment image features 618 along with the first set of verification image features 620a from the first verification image 604a to determine a first metric 624a, (ii) processes the set of enrollment image features 618 along with the second set of verification image features 620b from the second verification image 604b to determine a second metric 624b, (iii) processes the set of enrollment image features 618 along with the third set of verification image features 620c from the third verification image 604c to determine a third metric 624c, and so forth.

The RNN 628 includes memory 632 for storing information that is determined as a result of processing that is performed by the matching CNN 622. When a particular verification image is being processed, at least some of the information in the memory 632 may be taken into consideration. This is represented by the feedback loop 630 shown in FIG. 6. Thus, the metric that is determined by the RNN 628 in connection with processing a particular verification image may depend on information that was determined during the processing of one or more previous verification images. For example, the calculation of the second metric 624b (corresponding to the second verification image 604b) may depend on the calculation of the first metric 624a (corresponding to the first verification image 604a). Similarly, the calculation of the third metric 624c (corresponding to the third verification image 604c) may depend on the calculation of the first metric 624a and the second metric 624b. In other words, the RNN 628 may be configured to aggregate matching confidence over time as additional verification images 604a-c are processed.

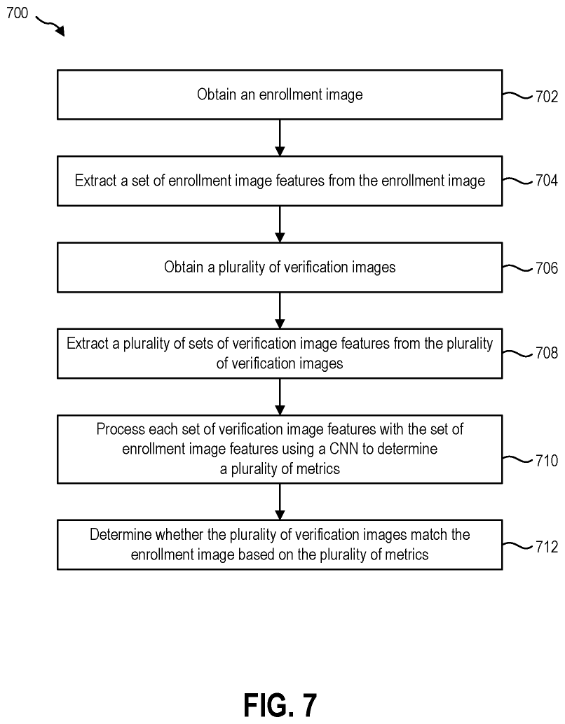

FIG. 7 illustrates an example of a method 700 for biometric verification in a biometric verification system that utilizes temporal information in connection with biometric verification. The method 700 may be performed by one or more computing devices. The method 700 will be described in relation to the system 600 shown in FIG. 6.

The method 700 includes obtaining 702 an enrollment image 602 and extracting 704 a set of enrollment image features 618 from the enrollment image 602. These actions 702, 704 may be similar to the corresponding actions 302, 304 that were described above in connection with the method 300 shown in FIG. 3.

The method 700 also includes obtaining 706 a plurality of verification images 604a-c and extracting 708 a plurality of sets of verification image features 620a-c from the plurality of verification images 604a-c. These actions 706, 708 may be similar to the corresponding actions 306, 308 that were described above in connection with the method 300 shown in FIG. 3, except that the actions 706, 708 shown in FIG. 7 involve a plurality of verification images 604a-c and a plurality of sets of verification image features 620a-c instead of just a single verification image 204 and a single set of verification image features 220.

The method 700 also includes processing 710 each set of verification image features 620 in the plurality of sets of verification image features 620a-c with the set of enrollment image features 618 using a matching CNN 622 to determine a plurality of metrics 624a-c. A separate metric 624 may be determined for each set of verification image features 620. In addition, the method 700 includes determining 712 whether the plurality of verification images 604a-c match the enrollment image 602 based on the plurality of metrics 624a-c. These actions 710, 712 may be similar to the corresponding actions 310, 312 that were described above in connection with the method 300 shown in FIG. 3, except that the actions 710, 712 shown in FIG. 7 involve a plurality of verification images 604a-c and a plurality of sets of verification image features 620a-c instead of just a single verification image 204 and a single set of verification image features 220.

In some embodiments, if at least one metric 624 of the plurality of metrics 624a-c exceeds a pre-defined threshold value, then a determination is made that the plurality of verification images 604a-c match the enrollment image 602. If, however, none of the plurality of metrics 624a-c exceed the threshold value, then a determination is made that the plurality of verification images 604a-c do not match the enrollment image 602. In other embodiments, the plurality of metrics 624a-c may be aggregated in some way. For example, an average of at least some of the plurality of metrics 624a-c may be determined. This aggregated metric may then be compared with the threshold value to determine whether the plurality of verification images 604a-c match the enrollment image 602.

As with the methods 300, 500 described previously, a computing device may perform some, but not all, of the actions of the method 700. For example, instead of performing the actions of obtaining 702 an enrollment image 602 and extracting 704 a set of enrollment image features 618 from the enrollment image 602, a computing device may instead obtain a set of enrollment image features 618 from another device. The computing device may then obtain 706 a plurality of verification images 604a-c and perform the rest of the method 700 in the manner described above.

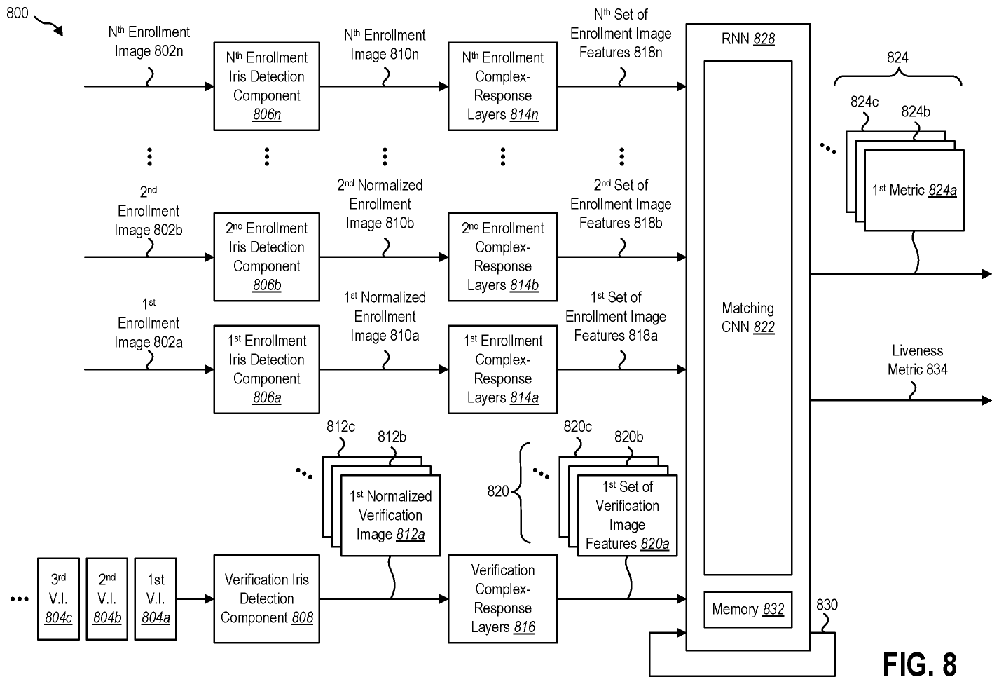

FIG. 8 illustrates another example of an iris verification system 800 in accordance with the present disclosure. Like the system 600 shown in FIG. 6, the system 800 shown in FIG. 8 is configured to utilize temporal information in connection with iris verification. However, whereas the system 600 shown in FIG. 6 only considers a single enrollment observation, the system 800 shown in FIG. 8 is configured to incorporate a plurality of enrollment observations corresponding to a plurality of enrollment images 806a-n. The plurality of enrollment images 806a-n include a first enrollment image 806a, a second enrollment image 806b, and an Nth enrollment image 806n. Like the systems 100, 200, 400, 600 discussed previously, the system 800 shown in FIG. 8 includes an iris detection section, a feature extraction section, and a matching section.

The iris detection section includes an enrollment iris detection component for each of a plurality of enrollment images 802a-n. In particular, FIG. 8 shows the iris detection section with a first enrollment iris detection component 806a, a second enrollment iris detection component 806b, and an Nth enrollment iris detection component 806n. The first enrollment iris detection component 806a performs iris detection with respect to the first enrollment image 802a and outputs a first normalized enrollment image 810a. The second enrollment iris detection component 806b performs iris detection with respect to the second enrollment image 802b and outputs a second normalized enrollment image 810b. The Nth enrollment iris detection component 806n performs iris detection with respect to the Nth enrollment image 802n and outputs an Nth normalized enrollment image 810n.

The iris detection section also includes a verification iris detection component 808 that performs iris detection with respect to each of the plurality of verification images 804a-c. For each verification image, the verification iris detection component 808 outputs a normalized verification image corresponding to the verification image. Thus, the verification iris detection component 808 (i) performs iris detection with respect to the first verification image 804a to produce a first normalized verification image 812a, (ii) performs iris detection with respect to the second verification image 804b to produce a second normalized verification image 812b, (iii) performs iris detection with respect to the third verification image 804c to produce a third normalized verification image 812c, and so forth.

The feature extraction section includes an enrollment C-R layer for each of the plurality of enrollment images 806a-n. In particular, FIG. 8 shows the feature extraction section with a first enrollment C-R layer 814a, a second enrollment C-R layer 806b, and an Nth enrollment C-R layer 806n. The first enrollment C-R layer 814a extracts a first set of enrollment image features 818a from the first normalized enrollment image 810a. The second enrollment C-R layer 814b processes the second normalized enrollment image 810b to extract a second set of enrollment image features 818b from the second normalized enrollment image 810b. The Nth enrollment C-R layer 814n processes the Nth normalized enrollment image 810n to extract an Nth set of enrollment image features 818n from the Nth normalized enrollment image 810n.

The feature extraction section also includes a verification C-R layer 816 that extracts a set of verification image features from each of the normalized verification images 812a-c. In particular, the verification C-R layer 816 (i) extracts a first set of verification image features 820a from the first normalized verification image 812a, (ii) extracts a second set of verification image features 820b from the second normalized verification image 812b, (iii) extracts a third set of verification image features 820c from the third normalized verification image 812c, and so forth.

The matching section includes an RNN 828. The RNN 828 includes a matching CNN 822 that processes the sets of enrollment image features 818a-n along with a particular set of verification image features from a particular verification image to determine a metric that indicates the probability of a match between the enrollment images 802a-n and the verification image under consideration. Thus, the matching CNN 822 (i) processes the sets of enrollment image features 818a-n along with the first set of verification image features 820a from the first verification image 804a to determine a first metric 824a, (ii) processes the sets of enrollment image features 818a-n along with the second set of verification image features 820b from the second verification image 804b to determine a second metric 824b, (iii) processes the sets of enrollment image features 818a-n along with the third set of verification image features 820c from the third verification image 804c to determine a third metric 824c, and so forth.

Like the RNN 428 in the system 600 shown in FIG. 6, the RNN 828 includes memory 832 for storing information that is determined as a result of processing that is performed by the matching CNN 822. The RNN 828 also includes a feedback loop 830, indicating that at least some of the information in the memory 832 may be taken into consideration when a particular verification image is being processed. Thus, the metric that is determined by the RNN 828 in connection with processing a particular verification image may depend on information that was determined during the processing of one or more previous verification images. For example, the calculation of the second metric 824b (corresponding to the second verification image 804b) may depend on the calculation of the first metric 824a (corresponding to the first verification image 804a). Similarly, the calculation of the third metric 824c (corresponding to the third verification image 804c) may depend on the calculation of the first metric 824a and the second metric 824b. In other words, the RNN 828 may be configured to aggregate matching confidence over time as additional verification images 804a-c are processed.

In addition to the metrics 824a-c that indicate the probability that the enrollment images 802a-n correspond to the same human eye as the verification image under consideration, the RNN 828 in the system 800 shown in FIG. 8 may also be configured to produce a metric 834 that indicates the probability that the verification images 804a-c represent a live human being. This metric 834 may be referred to herein as a liveness metric 834. The liveness metric 834 may be updated as additional verification images 804a-c are processed. Generally speaking, the greater the number of verification images 804a-c that have been processed, the greater the accuracy of the liveness metric 834.

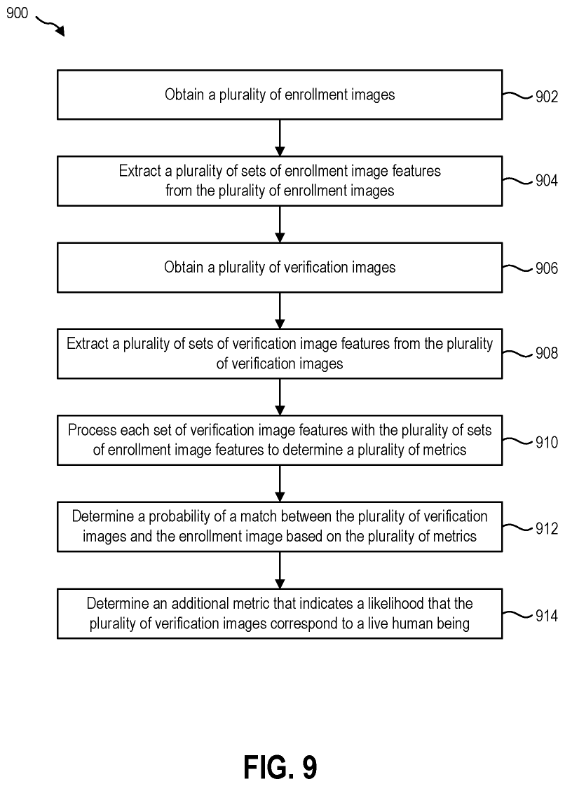

FIG. 9 illustrates an example of a method 900 for biometric verification in a biometric verification system that utilizes temporal information in connection with biometric verification and also accommodates a plurality of enrollment observations. The method 900 may be performed by one or more computing devices. The method 900 will be described in relation to the system 800 shown in FIG. 8.

The method 900 includes obtaining 902 a plurality of enrollment images 802a-n and extracting 904 a plurality of sets of enrollment image features 818a-n from the plurality of enrollment images 802a-n. These actions 902, 904 may be similar to the corresponding actions 302, 304 that were described above in connection with the method 300 shown in FIG. 3, except that the actions 902, 904 shown in FIG. 9 involve a plurality of enrollment images 802a-n and a plurality of sets of enrollment image features 818a-n instead of just a single enrollment image 202 and a single set of enrollment image features 202a-n.

The method 900 also includes obtaining 906 a plurality of verification images 804a-c and extracting 908 a plurality of sets of verification image features 820a-c from the plurality of verification images 804a-c. These actions 906, 908 may be similar to the corresponding actions 306, 308 that were described above in connection with the method 300 shown in FIG. 3, except that the actions 906, 908 shown in FIG. 9 involve a plurality of verification images 804a-c and a plurality of sets of verification image features 820a-c instead of just a single verification image 204 and a single set of verification image features 220.

The method 900 also includes processing 910 each set of verification image features 820 in the plurality of sets of verification image features 820a-c with the plurality of sets of enrollment image features 818a-n using a matching CNN 822 to determine a plurality of metrics 824a-c. A separate metric 824 may be determined for each set of verification image features 820. In addition, the method 900 includes determining 912 whether the plurality of verification images 804a-c match the plurality of enrollment images 802a-n based on the plurality of metrics 824a-c. These actions 910, 912 may be similar to the corresponding actions 310, 312 that were described above in connection with the method 300 shown in FIG. 3, except that the actions 910, 912 shown in FIG. 9 involve a plurality of verification images 804a-c, a plurality of sets of verification image features 820a-c, a plurality of enrollment images 802a-n, and a plurality of sets of enrollment image features 818a-n instead of just a single verification image 204, a single set of verification image features 220, a single enrollment image 202, and a single set of enrollment image features 218.

In some embodiments, if at least one metric 824 of the plurality of metrics 824a-c exceeds a pre-defined threshold value, then a determination is made that the plurality of verification images 804a-c match the plurality of enrollment images 802a-n. If, however, none of the plurality of metrics 824a-c exceed the threshold value, then a determination is made that the plurality of verification images 804a-c do not match the plurality of enrollment images 802a-n. In other embodiments, the plurality of metrics 824a-c may be aggregated in some way. For example, an average of at least some of the plurality of metrics 824a-c may be determined. This aggregated metric may then be compared with the threshold value to determine whether the plurality of verification images 804a-c match the plurality of enrollment images 802a-n.

The method 900 also includes determining 914 an additional metric 834 (which may be referred to as a liveness metric 834) that indicates a likelihood that the plurality of verification images 804a-c correspond to a live human being. As indicated above, this liveness metric 834 may be updated as additional verification images 804a-c are processed.

As with the methods 300, 500, 700 described previously, a computing device may perform some, but not all, of the actions of the method 900. For example, instead of performing the actions of obtaining 902 a plurality of enrollment images 802a-n and extracting 904 a plurality of sets of enrollment image features 818a-n from the plurality of enrollment images 802a-n, a computing device may instead obtain a plurality of sets of enrollment image features 818a-n from another device. The computing device may then obtain 906 a plurality of verification images 804a-c and perform the rest of the method 900 in the manner described above.

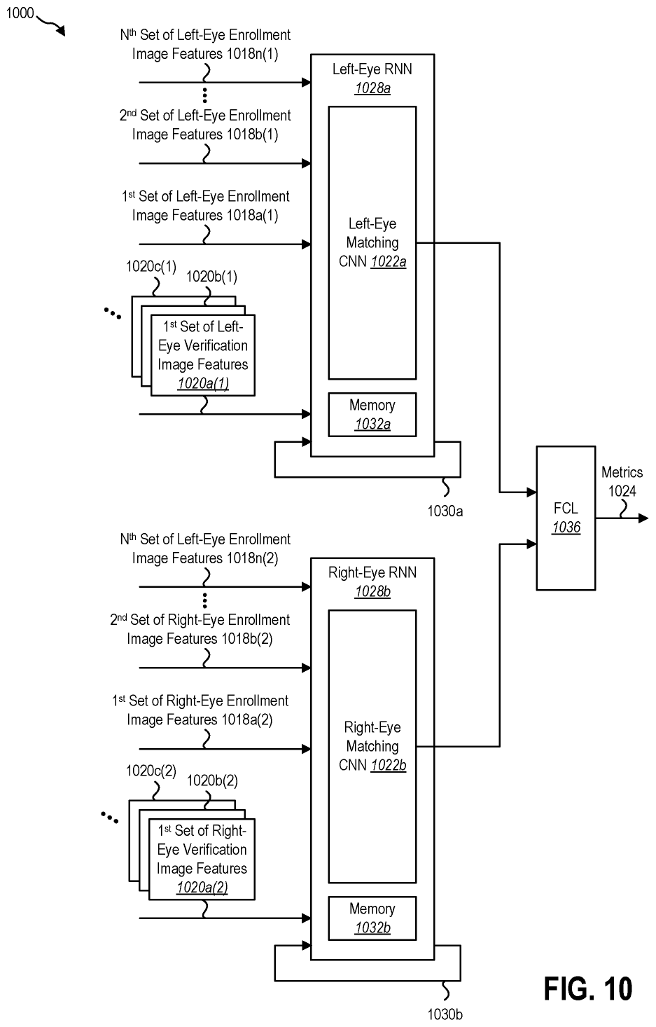

FIG. 10 illustrates another example of an iris verification system 1000 in accordance with the present disclosure. The system 1000 shown in FIG. 10 is configured to accommodate enrollment and verification observations for two eyes: a person's left eye and a person's right eye. Generally speaking, an iris verification system that processes enrollment and verification observations corresponding to two eyes is more accurate than an iris verification system that only processes enrollment and verification observations corresponding to a single eye.

Like the systems 100, 200, 400, 600, 800 discussed previously, the system 1000 shown in FIG. 10 may include an iris detection section, a feature extraction section, and a matching section. For simplicity, however, only the matching section (and the corresponding inputs) are shown in FIG. 10.

The system 1000 includes two RNNs 1028a-b. In particular, the system includes an RNN 1028a for processing enrollment and verification observations corresponding to the left eye and an RNN 1028b for processing enrollment and verification observations corresponding to the right eye. The former will be referred to herein as a left-eye RNN 1028a, and the latter will be referred to herein as a right-eye RNN 1028b.

The left-eye RNN 1028a receives a plurality of sets of enrollment image features corresponding to different enrollment observations of a person's left eye. In particular, FIG. 10 shows a first set of left-eye enrollment image features 1018a(1) corresponding to a first enrollment image, a second set of left-eye enrollment image features 1018b(1) corresponding to a second enrollment image, and an Nth set of left-eye enrollment image features 1018n(1) corresponding to an Nth enrollment image.

The left-eye RNN 1028a also receives a plurality of sets of verification image features corresponding to a plurality of verification images. The plurality of verification images may be, for example, image frames from a video of a person's left eye. The video may be taken at the time when verification is performed. FIG. 10 shows a first set of left-eye verification image features 1020a(1) corresponding to a first verification image, a second set of left-eye verification image features 1020b(1) corresponding to a second verification image, a third set of left-eye verification image features 1020c(1) corresponding to a third verification image, and so forth.

The left-eye RNN 1028a includes a matching CNN 1022a that will be referred to herein as a left-eye matching CNN 1022a. The left-eye matching CNN 1022a processes the sets of enrollment image features 1018a(1)-1018a(n) along with a particular set of verification image features from a particular verification image to determine the probability that the enrollment images correspond to the same human eye as the verification image under consideration. Thus, the left-eye matching CNN 1022a (i) processes the sets of enrollment image features 1018a(1)-1018a(n) along with the first set of verification image features 1020a(1) from a first verification image, (ii) processes the sets of enrollment image features 1018a(1)-1018a(n) along with the second set of verification image features 1020b(1) from a second verification image, (iii) processes the sets of enrollment image features 1018a(1)-1018a(n) along with the third set of verification image features 1020c(1) from a third verification image, and so forth. The results of these processing operations may be provided to a fully connected layer (FCL) 1036, which will be discussed in greater detail below.

The left-eye RNN 1028a includes memory 1032a for storing information that is determined as a result of processing that is performed by the left-eye matching CNN 1022a. The left-eye RNN 1028a also includes a feedback loop 1030a, indicating that at least some of the information in the memory 1032a may be taken into consideration when a particular verification image is being processed. Thus, the information that is determined by the left-eye RNN 1028a in connection with processing a particular left-eye verification image may depend on information that was determined during the processing of one or more previous left-eye verification images.

The right-eye RNN 1028b operates similarly to the left-eye RNN 1028a, except that the operations performed by the right-eye RNN 1028b pertain to images of the right eye rather than images of the left eye. Thus, the right-eye RNN 1028b receives a plurality of sets of enrollment image features corresponding to different enrollment observations of a person's right eye. FIG. 10 shows a first set of right-eye enrollment image features 1018a(2) corresponding to a first right-eye enrollment image, a second set of right-eye enrollment image features 1018b(2) corresponding to a second right-eye enrollment image, and an Nth set of right-eye enrollment image features 1018n(2) corresponding to an Nth right-eye enrollment image.

The right-eye RNN 1028b also receives a plurality of sets of verification image features corresponding to a plurality of verification images. The plurality of verification images may be, for example, image frames from a video of a person's right eye. The video may be taken at the time when verification is performed. FIG. 10 shows a first set of right-eye verification image features 1020a(2) corresponding to a first verification image, a second set of right-eye verification image features 1020b(2) corresponding to a second verification image, a third set of right-eye verification image features 1020c(2) corresponding to a third verification image, and so forth.

The right-eye RNN 1028b includes a matching CNN 1022b that will be referred to herein as a right-eye matching CNN 1022b. The right-eye matching CNN 1022b processes the sets of enrollment image features 1018a(2)-1018n(2) along with a particular set of verification image features from a particular verification image to determine the probability that the enrollment images correspond to the same human eye as the verification image under consideration. Thus, the right-eye matching CNN 1022b (i) processes the sets of enrollment image features 1018a(2)-1018n(2) along with the first set of verification image features 1020a(2) from a first verification image, (ii) processes the sets of enrollment image features 1018a(2)-1018n(2) along with the second set of verification image features 1020b(2) from a second verification image, (iii) processes the sets of enrollment image features 1018a(2)-1018n(2) along with the third set of verification image features 1020c(2) from a third verification image, and so forth. The results of these processing operations may be provided to the FCL 1036.

The right-eye RNN 1028b includes memory 1032b for storing information that is determined as a result of processing that is performed by the right-eye matching CNN 1022b. The right-eye RNN 1028b also includes a feedback loop 1030b, indicating that at least some of the information in the memory 1032b may be taken into consideration when a particular verification image is being processed. Thus, the information that is determined by the right-eye RNN 1028b in connection with processing a particular right-eye verification image may depend on information that was determined during the processing of one or more previous right-eye verification images.

The FCL 1036 combines the information that is received from the left-eye RNN 1028a with the information that is received from the right-eye RNN 1028b to produce metrics 1024. The metrics 1024 indicate the probability that the left-eye enrollment images, left-eye verification images, right-eye enrollment images, and right-eye verification images all correspond to the same human eye.

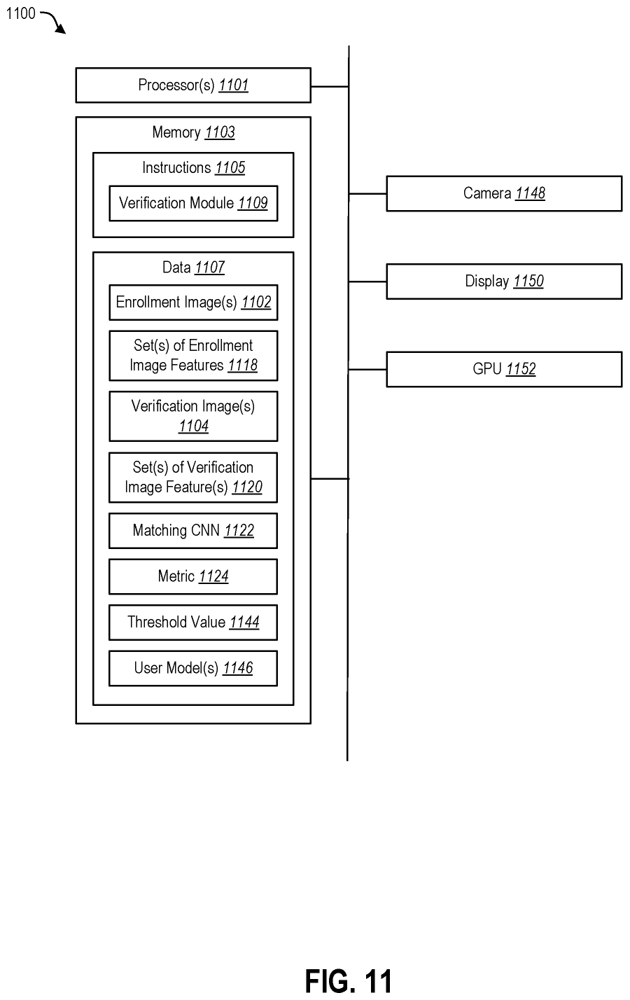

FIG. 11 illustrates certain components that may be included within a computing device 1100 that is configured to implement the techniques disclosed herein. The computing device 1100 includes one or more processors 1101. The processor(s) 1101 may include a general purpose single-chip and/or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, and so forth, including combinations thereof.

The computing device 1100 also includes memory 1103 in electronic communication with the processor(s) 1101. The memory 1103 may be any electronic component capable of storing electronic information. For example, the memory 1103 may be embodied as random access memory (RAM), read-only memory (ROM), magnetic disk storage media, optical storage media, flash memory devices in RAM, on-board memory included with the processor(s) 1101, erasable programmable read-only memory (EPROM), electrically erasable programmable read-only memory (EEPROM) memory, registers, and so forth, including combinations thereof.

Instructions 1105 and data 1107 may be stored in the memory 1103. The instructions 1105 may be executable by the processor(s) 1101 to implement some or all of the steps, operations, actions, or other functionality disclosed herein. Executing the instructions 1105 may involve the use of the data 1107 that is stored in the memory 1103. Unless otherwise specified, any of the various examples of modules and components described herein may be implemented, partially or wholly, as instructions 1105 stored in memory 1103 and executed by the processor(s) 1101. Any of the various examples of data described herein may be among the data 1107 that is stored in memory 1103 and used during execution of the instructions 1105 by the processor(s) 1101.

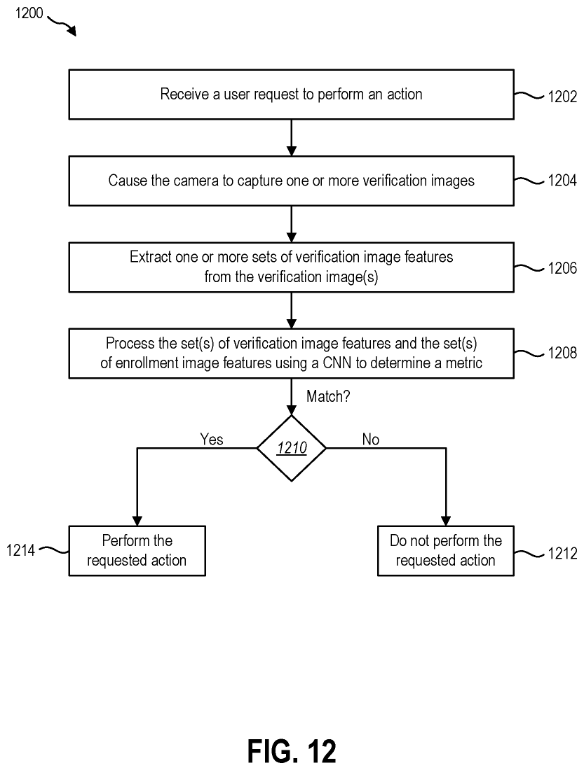

In the computing device 1100 shown in FIG. 11, the instructions 1105 include a verification module 1109. The verification module 1109 may be configured to perform biometric verification in accordance with the techniques disclosed herein. The verification module 1109 may be configured to perform any of the methods 300, 500, 700, 900 described herein. Another example of a method 1200 that may be implemented by the verification module 1109 will be described below in connection with FIG. 12. The data 1107 stored in the memory 1103 include various items that may be used by the verification module 1109 in connection with performing biometric verification, including one or more sets of enrollment image features 1118, one or more verification images 1104, one or more sets of verification image features 1120, a pre-defined threshold value 1144, and one or more user models 1146. These items will be described in greater detail below in connection with FIG. 12.

The computing device 1100 also includes a camera 1148 that may be configured to capture digital images, such as enrollment images 1102 and/or verification images 1104. The camera 1148 may include optics (e.g., one or more focusing lenses) that focus light onto an image sensor, which includes an array of photosensitive elements. The camera 1148 may also include circuitry that is configured to read the photosensitive elements to obtain pixel values that collectively form digital images.

The computing device 1100 may also include a display 1150. In some embodiments, the computing device 1100 may be a mixed reality device. In such embodiments, the display 1150 may include one or more semitransparent lenses on which images of virtual objects may be displayed. Different stereoscopic images may be displayed on the lenses to create an appearance of depth, while the semitransparent nature of the lenses allows the user to see both the real world as well as the virtual objects rendered on the lenses.

In some embodiments, the computing device 1100 may also include a graphics processing unit (GPU) 1152. In embodiments where the computing device 1100 is a virtual reality device, the processor(s) 1101 may direct the GPU 1152 to render the virtual objects and cause the virtual objects to appear on the display 1150.

FIG. 12 illustrates an example of a method 1200 for biometric verification that may be performed by the computing device 1100 shown in FIG. 11. The method 1200 includes receiving 1202 a request to perform an action. The action may involve some type of authentication. For example, authentication may be required in order to use the computing device 1100, and a request may be received 1202 to perform the required authentication.

One or more sets of enrollment image features 1118 may be stored on the computing device 1100. The set(s) of enrollment image features 1118 may correspond to one or more enrollment images 1102. In some embodiments, the enrollment images 1102 may be stored on the computing device 1100 as well. The camera 1148 may be used to capture the enrollment images 1102. In other embodiments, the enrollment images 1102 may not be stored on the computing device 1100, and the set(s) of enrollment image features 1118 may be obtained from another device.

In response to receiving 1202 the request to perform the action, the computing device 1100 may cause 1204 the camera 1148 to capture one or more verification images 1104. The method 1200 may also include extracting 1206 one or more sets of verification image features 1120 from the verification images 1104, as well as processing the set(s) of verification image features 1120 and the set(s) of enrollment image features 1118 using a matching CNN 1122 to determine a metric 1124. The actions of extracting 1206 and processing 1208 may be performed similarly to the corresponding actions 308, 310 that were described above in connection with the method 300 shown in FIG. 3 (or similar actions in other methods described herein).

The method 1200 also includes determining 1210 whether the verification image(s) 1104 match the enrollment image(s) 1102 based on the metric 1124. This determination may be made similarly to the corresponding determination 312 that was described above in connection with the method 300 shown in FIG. 3. If it is determined 1210 that the verification image(s) 1104 match the enrollment image(s) 1102, then the requested action may be performed 1212. If, however, it is determined 1210 that the verification image(s) 1104 do not match the enrollment image(s) 1102, then the requested action may not be performed 1214.

In embodiments where the computing device 1100 is a mixed reality device, the requested action may involve downloading a user model 1146 corresponding to a particular user of the mixed reality device. A user model 1146 may include information about the geometry of a user's eyes (e.g., the radius of the user's eyeball, where one eye is located in three-dimensional space with respect to the other eye). The information contained in a user model 1146 allows images of virtual objects to be presented on the display 1150 in a way that they can be correctly perceived by a particular user.

In some embodiments, a user model 1146 may be loaded automatically, without receiving a user request. For example, when the computing device 1100 is transferred from one user to another, the computing device 1100 may use the biometric verification techniques disclosed herein to identify the new user and automatically download a user model 1146 corresponding to the new user.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

In an example, the term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer-readable medium comprising instructions that are executable by one or more processors to cause a computing device to:
obtain a verification image;
extract a set of verification image features from the verification image;
process the set of verification image features and a set of enrollment image features using a convolutional neural network to determine a metric; and
determine whether the verification image matches an enrollment image based on the metric.

2. The computer-readable medium of claim 1, wherein the enrollment image and the verification image both comprise a human iris.

3. The computer-readable medium of claim 1, wherein the enrollment image and the verification image both comprise a human face.

4. The computer-readable medium of claim 1, wherein:
the set of verification image features are extracted from the verification image using a set of verification complex-response layers; and
the computer-readable medium further comprises additional instructions that are executable by the one or more processors to obtain the enrollment image and extract the set of enrollment image features from the enrollment image using a set of enrollment complex-response layers.

5. The computer-readable medium of claim 1, further comprising additional instructions that are executable by the one or more processors to process a plurality of sets of enrollment image features with the set of verification image features using the convolutional neural network to determine the metric.

6. The computer-readable medium of claim 1, wherein the convolutional neural network is included in a recurrent neural network, and further comprising additional instructions that are executable by the one or more processors to:
obtain a plurality of verification images;
extract a plurality of sets of verification image features from the plurality of verification images; and
process each set of verification image features with the set of enrollment image features to determine a plurality of metrics, wherein the metric that is determined in connection with processing a particular set of verification image features depends on information obtained in connection with processing one or more previous sets of verification image features.

7. The computer-readable medium of claim 6, further comprising additional instructions that are executable by the one or more processors to determine an additional metric that indicates a likelihood that the plurality of verification images correspond to a live human being.

8. The computer-readable medium of claim 1, wherein the convolutional neural network is included in a recurrent neural network, and further comprising additional instructions that are executable by the one or more processors to:
obtain a plurality of sets of enrollment image features corresponding to a plurality of enrollment images;
obtain a plurality of verification images;
extract a plurality of sets of verification image features from the plurality of verification images; and
process each set of verification image features with the plurality of sets of enrollment image features to determine a plurality of metrics, wherein the metric that is determined in connection with processing a particular set of verification image features depends on information obtained in connection with processing one or more previous sets of verification image features.

9. The computer-readable medium of claim 8, further comprising additional instructions that are executable by the one or more processors to determine an additional metric that indicates a likelihood that the plurality of verification images correspond to a live human being.

10. The computer-readable medium of claim 1, wherein the enrollment image comprises a left-eye enrollment image, wherein the verification image comprises a left-eye verification image, wherein the convolutional neural network comprises a left-eye convolutional neural network, and further comprising additional instructions that are executable by the one or more processors to:
obtain right-eye enrollment image features that are extracted from a right-eye enrollment image;
obtain right-eye verification image features that are extracted from a right-eye verification image; and
process the right-eye enrollment image features and the right-eye verification image features using a right-eye convolutional neural network, wherein the metric depends on output from the left-eye convolutional neural network and the right-eye convolutional neural network.

11. A computing device, comprising:
a camera;
one or more processors;
memory in electronic communication with the one or more processors;
a set of enrollment image features stored in the memory, the set of enrollment image features corresponding to an enrollment image;
instructions stored in the memory, the instructions being executable by the one or more processors to:
cause the camera to capture a verification image;
extract a set of verification image features from the verification image;
process the set of verification image features and the set of enrollment image features using a convolutional neural network to determine a metric; and
determine whether the verification image matches the enrollment image based on the metric.

12. The computing device of claim 11, further comprising additional instructions that are executable by the one or more processors to:
receive a user request to perform an action; and
perform the action in response to determining that the metric exceeds a pre-defined threshold value.

13. The computing device of claim 12, wherein the computing device comprises a head-mounted mixed reality device, and wherein the action comprises loading a user model corresponding to a user of the computing device.

14. The computing device of claim 11, further comprising:
a plurality of sets of enrollment image features stored in the memory; and
additional instructions that are executable by the one or more processors to process the plurality of sets of enrollment image features with the set of verification image features using the convolutional neural network to determine the metric.

15. The computing device of claim 11, further comprising additional instructions that are executable by the one or more processors to:
cause the camera to capture a plurality of verification images;
extract a plurality of sets of verification image features from the plurality of verification images; and
process each set of verification image features with the set of enrollment image features to determine a plurality of metrics, wherein the metric that is determined in connection with processing a particular set of verification image features depends on information obtained in connection with processing one or more previous sets of verification image features.

16. The computing device of claim 15, further comprising additional instructions that are executable by the one or more processors to determine an additional metric that indicates a likelihood that the plurality of verification images correspond to a live human being.

17. The computing device of claim 11, wherein the convolutional neural network is included in a recurrent neural network, and further comprising additional instructions that are executable by the one or more processors to:
obtain a plurality of sets of enrollment image features corresponding to a plurality of enrollment images;
cause the camera to capture a plurality of verification images;
extract a plurality of sets of verification image features from the plurality of verification images; and
process each set of verification image features with the plurality of sets of enrollment image features to determine a plurality of metrics, wherein the metric that is determined in connection with processing a particular set of verification image features depends on information obtained in connection with processing one or more previous sets of verification image features.

18. The computing device of claim 17, further comprising additional instructions that are executable by the one or more processors to determine an additional metric that indicates a likelihood that the plurality of verification images correspond to a live human being.

19. A system, comprising:
one or more processors;
memory in electronic communication with the one or more processors;
instructions stored in the memory, the instructions being executable by the one or more processors to:
receive a request from a client device to perform biometric verification;
receive a verification image from the client device;
process a set of verification image features and a set of enrollment image features using a convolutional neural network to determine a metric;
determine a verification result based on the metric; and
send the verification result to the client device.

20. The system of claim 19, further comprising additional instructions that are executable by the one or more processors to:
extract the set of verification image features from the verification image;
obtain an enrollment image; and
extract the set of enrollment image features from the enrollment image.
